(19) United States
(12) Patent Application Publication
(10) Pub. No.: US 2024/0235953 A1
(43) Pub. Date: Jul. 11, 2024

(54) METHOD OF USING ANALYTICS FEEDBACK INFORMATION FOR ANALYTICS ACCURACY OF NETWORK DATA AND APPARATUSES FOR PERFORMING THE SAME

(71) Applicant: ELECTRONICS AND TELECOMMUNICATIONS RESEARCH INSTITUTE, Daejeon (KR)

(72) Inventor: Soohwan LEE, Daejeon (KR)

(21) Appl. No.: 18/526,933

(22) Filed: Dec. 1, 2023

(30) Foreign Application Priority Data
Jan. 9, 2023 (KR) 10-2023-0003100
Jan. 20, 2023 (KR) 10-2023-0008508
Feb. 8, 2023 (KR) 10-2023-0016934
Feb. 9, 2023 (KR) 10-2023-0017490
Mar. 14, 2023 (KR) 10-2023-0033157
Oct. 11, 2023 (KR) 10-2023-0135096

(51) Int. Cl. H04L 41/16; H04L 41/14; H04W 4/50

(52) U.S. Cl. CPC H04L 41/16; H04L 41/14; H04W 4/50

(57) ABSTRACT

A method of using analytics feedback information for analytics accuracy of network data and apparatuses for performing the same are provided. The method of using analytics feedback information includes requesting a machine learning (ML) model, receiving feedback information of an information consumer provided with information generated through the ML model, monitoring accuracy of the ML model, and providing at least one of the feedback information and information on the accuracy.

### CROSS-REFERENCE TO RELATED APPLICATIONS

This application claims the benefit of Korean Patent Application No. 10-2023-0003100 filed on Jan. 9, 2023, Korean Patent Application No. 10-2023-0008508 filed on Jan. 20, 2023, Korean Patent Application No. 10-2023-0016934 filed on Feb. 8, 2023, Korean Patent Application No. 10-2023-0017490 filed on Feb. 9, 2023, Korean Patent Application No. 10-2023-0033157 filed on Mar. 14, 2023, and Korean Patent Application No. 10-2023-0135096 filed on Oct. 11, 2023, in the Korean Intellectual Property Office, the entire disclosures of which are incorporated herein by reference for all purposes.

### BACKGROUND

### 1. Field of the Invention

The following disclosure relates to a method of using analytics feedback information for analytics accuracy of network data and apparatuses for performing the same.

### 2. Description of the Related Art

To support network automation, a fifth generation (5G) telecommunication system defines a network data analytics function (NWDAF) that is a network function for providing a function to analyze data collected by the 5G network.

For automation and optimization of the 5G telecommunication system, the NWDAF may collect raw data of each network function and application function, may convert the raw data into big data, and may provide network analytics information by processing the big data.

The above description is information the inventor(s) acquired during the course of conceiving the present disclosure, or already possessed at the time, and is not necessarily art publicly known before the present application was filed.

### SUMMARY

According to an aspect, there is provided a method of using feedback information, including requesting a machine learning (ML) model, receiving feedback information of an information consumer provided with information generated through the ML model, monitoring accuracy of the ML model, and providing at least one of the feedback information and information on the accuracy.

The method further includes, when a consumer uses the ML model and has a capability of transmitting feedback information on analytics generated by the ML model, registering the consumer to a provider providing the ML model.

A request for the registering includes at least one of an identifier of a consumer provided with the ML model and an identifier of the ML model.

The providing includes transmitting the at least one in response to a request for subscription to accuracy monitoring of the ML model.

The method further includes computing the accuracy based on the feedback information.

The at least one is used for evaluation of the ML model.

The method further includes receiving the ML model that is retrained or a newly selected ML model based on the at least one.

The feedback information is received via a network exposure function (NEF).

The feedback information includes use case context.

According to an aspect, there is provided a server apparatus for using feedback information, including a processor, and a memory electrically connected to the processor and configured to store instructions executable by the processor, wherein the processor performs a plurality of operations when the instructions are executed by the processor, and wherein the plurality of operations includes requesting a machine learning (ML) model, receiving feedback information of a consumer provided with information generated through the ML model, monitoring accuracy of the ML model, and providing at least one of the feedback information and information on the accuracy.

The plurality of operations further includes, when a consumer uses the ML model and has a capability of transmitting feedback information on analytics generated by the ML model, registering the consumer to a provider providing the ML model.

A request for registration includes at least one of an identifier of a consumer provided with the ML model and an identifier of the ML model.

The providing includes transmitting the at least one in response to a request for subscription to accuracy monitoring of the ML model.

The plurality of operations further includes computing the accuracy based on the feedback information.

The at least one is used for evaluation of the ML model.

The plurality of operations further includes receiving the ML model that is retrained or a newly selected ML model based on the at least one.

The feedback information is received via an NEF.

The feedback information includes use case context.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a diagram illustrating a network system according to one embodiment;

FIG. 2 is a diagram illustrating a network data analytics process according to one embodiment;

FIG. 3 is a diagram illustrating an operation of a network data analytics function (NWDAF) according to one embodiment;

FIGS. 4A and 4B are diagrams illustrating a structure of an NWDAF according to one embodiment;

FIG. 5 is a diagram illustrating an example of a procedure for analytics subscription or unsubscription according to one embodiment;

FIG. 6 is a diagram illustrating an example of a procedure for analytics subscription or unsubscription according to one embodiment;

FIG. 7 illustrates an example of a procedure for machine learning (ML) model accuracy monitoring according to one embodiment;

FIG. 8 is a diagram illustrating a registration procedure for ML model accuracy monitoring according to one embodiment;

FIG. 9 illustrates another example of a procedure for ML model accuracy monitoring according to one embodiment; and

FIG. 10 is a schematic block diagram of an apparatus for performing an NWDAF according to one embodiment.

### DETAILED DESCRIPTION

The following detailed structural or functional description is provided as an example only and various alterations and modifications may be made to the examples. Here, the examples are not construed as limited to the disclosure and should be understood to include all changes, equivalents, and replacements within the idea and the technical scope of the disclosure.

Terms, such as first, second, and the like, may be used herein to describe components. Each of these terminologies is not used to define an essence, order or sequence of a corresponding component but used merely to distinguish the corresponding component from other component(s). For example, a first component may be referred to as a second component, and similarly the second component may also be referred to as the first component.

It should be noted that if one component is described as being “connected”, “coupled”, or “joined” to another component, a third component may be “connected”, “coupled”, and “joined” between the first and second components, although the first component may be directly connected, coupled, or joined to the second component.

The singular forms “a”, “an”, and “the” are intended to include the plural forms as well, unless the context clearly indicates otherwise. As used herein, “A or B,” “at least one of A and B,” “at least one of A or B,” “A, B or C,” “at least one of A, B and C,” and “at least one of A, B, or C,” each of which may include any one of the items listed together in the corresponding one of the phrases, or all possible combinations thereof. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms used herein including technical or scientific terms have the same meaning as commonly understood by one of ordinary skill in the art to which examples belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

As used in connection with the present disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an example, the module may be implemented in a form of an application-specific integrated circuit (ASIC).

The term “unit” used herein may refer to a software or hardware component, such as a field-programmable gate array (FPGA) or an ASIC, and the “unit” performs predefined functions. However, “unit” is not limited to software or hardware. The “unit” may be configured to reside on an addressable storage medium or configured to operate one or more processors. Accordingly, the “unit” may include, for example, components, such as software components, object-oriented software components, class components, and task components, processes, functions, attributes, procedures, sub-routines, segments of program code, drivers, firmware, microcode, circuitry, data, databases, data structures, tables, arrays, and variables. The functionalities provided in the components and “units” may be combined into fewer components and “units” or may be further separated into additional components and “units.” Furthermore, the components and “units” may be implemented to operate on one or more central processing units (CPUs) within a device or a security multimedia card. In addition, “unit” may include one or more processors.

Hereinafter, the embodiments will be described in detail with reference to the accompanying drawings. When describing the embodiments with reference to the accompanying drawings, like reference numerals refer to like elements and a repeated description related thereto will be omitted.

Terms used herein to identify a connection node, to indicate network entities, to indicate messages, to indicate an interface among network entities, to indicate various pieces of identification information are examples for ease of description. Thus, terms are not limited to terms described later in this disclosure and other terms referring to a subject having the equivalent technical meaning may be used.

Herein, for ease of description, of the currently existing communication standards, terms and names defined by long-term evolution (LTE) and new radio (NR) standards, which are the latest standards defined by the third generation partnership project (3GPP) association, are used. However, embodiments described hereinafter are not limited to the terms and names and a system in compliance with other standards may be applicable in the same manner.

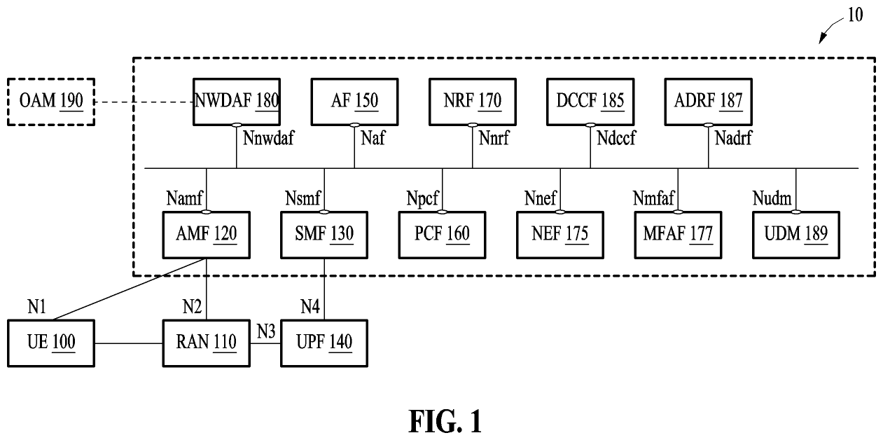

FIG. 1 is a diagram illustrating a network system according to one embodiment.

Referring to FIG. 1, according to one embodiment, a network system 10 (e.g., a 5G network system) may include a plurality of entities 100 to 190. User equipment (UE) (or a user terminal) 100 may be connected to a 5G core network via a radio access network (RAN) 110. The RAN 110 may be a base station providing a wireless communication function to the UE 100. An operation, administration, and maintenance (OAM) 190 may be a system for managing a terminal and a network.

A unit in which each function provided by the network system 10 may be defined as a network function (NF). The NF may include an access and mobility management function (AMF) 120, a session management function (SMF) 130, a user plane function (UPF) 140, an application function (AF) 150, a policy control function (PCF) 160, a network repository function (NRF) 170, a network exposure function (NEF) 175, a messaging framework adapter function (MFAF) 177, a network data analytics function (NWDAF) 180, a data collection coordination function (DCCF) 185, an analytics data repository function (ADRF) 187, and a unified data management (UDM) 189. The AMF 120 may manage network access and mobility of a terminal, the SMF 130 may perform a function associated with a session, the UPF 140 may transmit user data, and the AF 150 may communicate with a 5G core (5GC) to provide an application service. The PCF 160 may manage a policy, and the NRF 170 may store status information of an NF and may process a request to find an NF accessible by other NFs.

The NWDAF 180 may provide an analytics result by analyzing data collected in a network (e.g., a 5G network) to support network automation. The NWDAF 180 may collect, store, and analyze information from the network. The NWDAF 180 may collect information from the OAM 190, an NF (e.g., the AMF 120, the SMF 130, the UPF 140, the PCF 160, the NRF 170, the NEF 175, the MFAF 177, the DCCF 185, the ADRF 187, and/or the UDM 189) constituting a network, the UE, or the AF 150. The NWDAF 180 may provide an analytics result to an unspecified NF (e.g., the AMF 120, the SMF 130, the UPF 140, the PCF 160, the NRF 170, the NEF 175, the MFAF 177, the DCCF 185, the ADRF 187, and/or the UDM 189), the OAM 190, the UE, or the AF 150. The analytics result may be independently used by each NF (e.g., the AMF 120, the SMF 130, the UPF 140, the PCF 160, the NRF 170, the NEF 175, the MFAF 177, the DCCF 185, the ADRF 187, and/or the UDM 189), the OAM 190, the UE, or the AF 150.

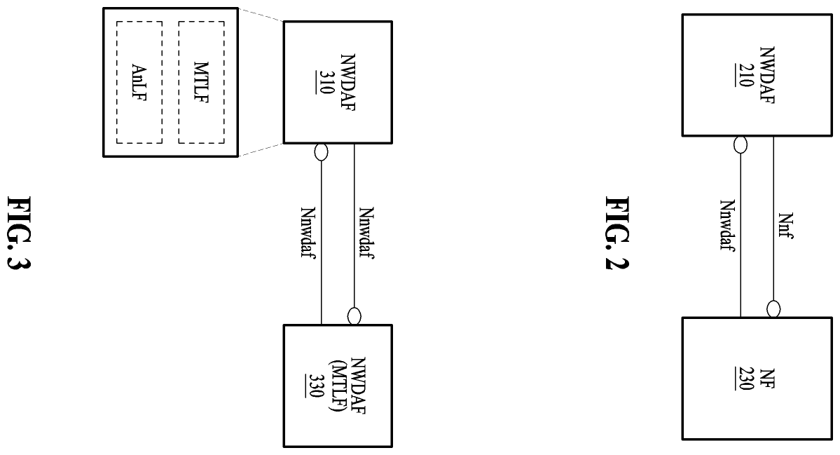

FIG. 2 is a diagram illustrating a network data analytics process according to one embodiment.

An NWDAF 210 may provide an analytics information subscription service (Nnwdaf_AnalyticsSubscription service) to an NF 230. The NF 230 may be the UE 100, the RAN 110, the AMF 120, the SMF 130, the UPF 140, the AF 150, the PCF 160, the NRF 170, the NEF 175, the MFAF 177, the DCCF 185, the ADRF 187, and/or the OAM 190 of FIG. 1. The NF 230 may be an NWDAF that is different from the NWDAF 210.

The analytics information subscription service may be a service to subscribe to or unsubscribe from a network data analytics result generated by the NWDAF 210. In addition, the analytics information subscription service may be a service to selectively subscribe to or unsubscribe from analytics accuracy information. The analytics information subscription service may be divided into periodically receiving a network analytics result and/or analytics accuracy information according to the needs of a network function of the NF 230 that subscribes to the service and receiving an analytics result and/or the analytics accuracy information when a predetermined condition is satisfied. The analytics information subscription service may be provided through three operations of subscription, unsubscription, and notification.

The subscription operation (Nnwdaf_AnlayticsSubscription_Subscribe operation) may subscribe to NWDAF analytics and/or analytics accuracy information using specific parameters. The subscription operation (Nnwdaf_AnlayticsSubscription_Subscribe operation) may selectively subscribe to the analytics accuracy information. The subscription operation (Nnwdaf_AnlayticsSubscription_Subscribe operation) may include a required input and/or an optional input. The required input may include a single network slice selection assistance information (S-NSSAI), an event identifier (ID) or an analytics ID, a notification target address, and an event reporting information. The optional input may include information additionally required for analytics information processing. For example, the optional input may include information about an event filter or an analytics filter (or an analytics information filter). However, the example is not limited thereto.

An example of one or more parameters included in the Nnwdaf_AnlayticsSubscription_Subscribe service operation may be as follows:

(1) Inputs, Required:
Analytics ID (or a set of analytics IDs);
Target of analytics reporting;
Notification target address (+Notification correlation ID);
Analytics reporting parameters (e.g., including an analytics target period, etc.).

The target of analytics reporting may be provided for each individual analytics ID.

(2) Inputs, Optional:
Analytics filter information;
Time window for collecting historical analytics;
Subscription correlation ID (e.g., in the case of modification of analytics subscription);
Preferred level of accuracy of the analytics;
Preferred level of accuracy per analytics subset;
Reporting thresholds;
Maximum number of requested objects (max);
Preferred order of results, maximum number of requested SUPIs (SUPImax);
Time when analytics information is needed;
Analytics metadata request;
NWDAF identifier (or a set of NWDAF identifiers) used by a consumer NF (e.g., an NWDAF service consumer) when aggregating multiple analytics subscriptions
Dataset statistical properties;
Output strategy;
Data time window;
Serving area of the consumer NF or NF ID;
Information on previous analytics subscription (e.g., an NWDAF identifier (e.g., an instance ID or a set ID), an analytics ID (e.g., including an SUPI with respect to UE-related analytics and analytics filter information), and a subscription correlation ID);
Analytics accuracy request information.
Analytics feedback information:

The analytics feedback information indicates that an analytics consumer NF has taken an action affected by previously provided analytics (e.g., an analytics result), which may or may not affect ground truth data corresponding to an analytics ID requested at the time when prediction refers to, and may consequently affect ML model accuracy monitoring by subscription using the following parameter(s). In addition, the following parameters are included:
Analytics ID used to take an action;
(If available) Indication whether the action affects ground truth data;
Timestamp when the action is performed.
Use case context (e.g., indicates a use case and an environment in which analytics (or analytics information) is used)

Analytics filter information, reporting thresholds, a maximum number of requested objects (max), a maximum number of requested SUPIs (SUPImax), an analytics metadata request, dataset statistical properties, an output strategy, a data time window, and a required time for analytics information may be provided per individual analytics ID.

The analytics feedback information may be included in a modification request for an existing analytics subscription.

(3) Output, Required:

Subscription correlation ID if the subscription is accepted (required to manage the subscription)

Error response if the subscription is not accepted

(4) Outputs, Optional:

When a consumer NF (e.g., an analytics consumer) requests for immediate reporting, a first corresponding analytics report may be included, if available.

When a target of analytics reporting is a SUPI or a GPSI, the subscription may not be accepted (e.g., the user consent may not be granted and an error may be sent to the user). When a target of analytics reporting is an internal group ID, a list of SUPIs or GPSIs, or UE, no error may be sent but when the user consent is not granted, a SUPI or a GPSI may be skipped.

In the case of an unsubscription operation (Nnwdaf_AnlayticsSubscription_Unsubscribe operation), the NF 230 may transmit subscription ID information to the NWDAF 180 and the NWDAF 210 may transmit a message notifying confirmation of unsubscription to the NF 230 requesting unsubscription as an output.

The notification operation (Nnwdaf_AnlayticsSubscription_Notify operation) may be that the NWDAF 210 notifies the NF 230, which successfully subscribes to the analytics information subscription service, of a specified network data analytics result periodically or when a predetermined condition is satisfied, and/or analytics accuracy information. The notification operation may include an event ID or an analytics ID (or analytics information ID) and a notification target address.

The NWDAF 210 may provide an analytics information request service to the NF 230. Unlike the analytics information subscription service, the analytics information request service may be a service in which the NF 230 requests analytics on predetermined information and/or analytics accuracy information and receives a result value as soon as the request is completed. An operation of the analytics information request service may include a request and a response. The NF 230 that requests analytics information and/or analytics accuracy information may transmit an analytics information request message to the NWDAF 180.

The NWDAF 210 may transmit the analytics result and/or the analytics accuracy information to each requesting NF 230. The analytics result and/or the analytics accuracy information may be used to optimize the performance of an operation (or a network function) (e.g., quality of service (QoS) management, traffic control, mobility management, load balancing, and power management of a terminal) performed by the NF 230.

The NF 230 may be a consumer NF (or a demander NF) requesting the NWDAF 210 for the analytics result and/or the analytics accuracy information and may provide feedback on the analytics result (e.g., analytics feedback information) to the NWDAF 210. The NF 230 may be a consumer NF (e.g., a service consumer NF) of the network data analytics service. The NWDAF 210 may function to collect and analyze data from each NF 230 to generate the analytics result and/or the analytics accuracy information requested by the consumer NF and may improve the accuracy of analytics information by collecting the analytics feedback information from the consumer NF to which the NWDAF 210 provided analytics. The NWDAF 210 may transmit the analytics result and/or the analytics accuracy information to the consumer NF transmitting the analytics request (e.g., including analytics and/or analytics accuracy information). Accordingly, the NWDAF 210 may be a provider NF of the analytics result and/or the analytics accuracy information requested by the consumer NF. The NWDAF 210 may be a service provider NF of a service that provides an analytics result requested by a consumer NF.

The NWDAF 210 may include at least one of an analytics logical function (AnLF) and a model training logical function (MTLF). The NWDAF 210 may include the MTLF and AnLF, respectively, or may support both.

The NWDAF (e.g., the NWDAF 210) including the AnLF may perform inference and may derive analytics information and/or analytics accuracy information (e.g., derive statistics and/or prediction and/or analytics accuracy in response to an analytics consumer request or a request by an analytics model provider (an NWDAF including an MTLF). The NWDAF including the AnLF may expose a network data analytics service (e.g., Nnwdaf_AnalyticsSubscription or Nnwdaf_AnalyticsInfo).

An NWDAF (e.g., the NWDAF 210) including the MTLF may train a machine learning (ML) model and may expose a new training service (e.g., provide an initial version that is not trained or a trained model).

When an ML model may be provided and/or trained for an analytics ID, the NWDAF including the MTLF may register (e.g., register to the NRF) an ML model provisioning service, a training service, and a monitoring service (e.g., Nnwdaf_MLModelProvision, Nnwdaf_MLModelInfo, Nnwdaf_MLModelUpdate, Nnwdaf_MLModelTraining, and Nnwdaf_MLModelTrainingInfo).

When the ML model is ready for use and/or monitoring by the NWDAF including the AnLF, the NWDAF including the AnLF may register (e.g., register to the NWDAF including the MTLF) an ML model monitoring service (e.g., Nnwdaf_MLModelMonitor).

The NWDAF including the MTLF may collect feedback (e.g., analytics feedback information) on an analytics result of using the ML model provided through the ML model monitoring service and/or analytics accuracy information from the NWDAF including the AnLF.

Hereinafter, a method of determining accuracy of analytics information by an NWDAF is described.

An NWDAF may have a capability of examining the accuracy (accuracy checking capability) of analytics and/or an ML model, and in response to a request, the NWDAF may provide accuracy information to a consumer or may use the accuracy information for an internal process.

Input data may be collected from a data producer NF in response to an inference or prediction request for each analytics ID of the NWDAF for a specific time period in future, and ground truth data may be collected from a data producer NF corresponding to a requested analytics ID when prediction refers to. The ground truth data may be actual measured data observed when prediction refers to.

When an action triggered by an analytics output of a consumer is shown in the analytics feedback information, the ground truth data may be affected.

The analytics or ML model accuracy monitoring may be performed by comparing predictions using a currently trained ML model and corresponding ground truth data (e.g., corresponding true observed events). The analytics accuracy information and ML model accuracy information (e.g., a result of analytics or ML model accuracy monitoring) may indicate general performance measurement of the analytics and the ML model, respectively, where the information may be constituted by the number of correct predictions among the total predictions and the number of corresponding samples.

A method of determining the accuracy of prediction by an MTLF or AnLF may vary depending on implementation.

The NWDAF (e.g., the NWDAF including the AnLF and/or the MTLF) having the accuracy checking capability may determine to begin analytics accuracy monitoring based on the following.
Request by an analytics accuracy consumer. For example, the analytics accuracy consumer may be an NWDAF including the AnLF and/or an NWDAF including the MTLF and/or the analytics consumer NF.
Analytics feedback information provided by the analytics consumer NF.

The AnLF having an analytics accuracy checking capability may provide or notify an analytics consumer of a corresponding service of accuracy information of an analytics ID, and when the analytics accuracy does not satisfy a requirement of the analytics consumer, the analytics consumer may stop the use of analytics for a predetermined period or may be provided with new analytics. In addition, when updated analytics for the provided analytics ID are able to be generated in a correction time period, the updated analytics may be provided in response to a request of the analytics consumer.

The AnLF having the analytics accuracy checking capability may determine the analytics accuracy information based on the following:
Comparing prediction generated based on an ML model with the corresponding ground truth data
Determining analytics accuracy by comparing analytics accuracy using multiple ML models

The MTLF having an ML model accuracy checking capability may determine ML model performance degradation based on the following:
Data including input data and/or analytics results and/or ground truth data (e.g., ground truth data collected from various data source NFs, a DCCF, an AnLF, an ADRF, and a UDM, or ground truth data configured by an OAM); or
AnLF providing a notification of the analytics accuracy information; or
AnLF providing analytics feedback information on analytics generated by the ML model

The NWDAF including the MTLF may reselect a new ML model or retrain an existing ML model, and consequently, may notify an ML model consumer of ML model accuracy degradation. In addition, the NWDAF including the MTLF may consider the rating of an unreliable AF when using the unreliable AF as a data source.

FIG. 3 is a diagram illustrating an operation of an NWDAF according to one embodiment.

The NWDAF 310 includes at least one of an AnLF and an MTLF and the NWDAF 330 includes an MTLF.

The NWDAF 310 may use a provisioning service operation (e.g., Nnwdaf_MLModelProvision) and a training service operation (e.g., Nnwdaf_MLModelTraining) for an ML model trained in an NWDAF 330.

The AnLF may perform inference, may derive (e.g., derive statistics and/or prediction in response to an analytics consumer request) analytics information, and may expose an analytics service (e.g., Nnwdaf_AnalyticsSubscription or Nnwdaf_AnalyticsInfo). The MTLF may train an ML model and may expose a new training service (e.g., provide a trained ML model and train an ML model). The AnLF and/or the MTLF may perform ML model analytics accuracy monitoring and may expose analytics accuracy information of the ML model. An operation of ML model analytics accuracy monitoring may include an operation of generating the analytics accuracy information of the ML model.

The AnLF may support an analytics information request service (e.g., Nnwdaf_AnalyticsInfo) or an analytics subscription service (e.g., Nnwdaf_AnalyticsSubscription). The MTLF may support an ML model provisioning service (e.g., Nnwdaf_MLModelProvision), an ML model information request service (e.g., Nnwdaf_MLModelInfo), an ML model training service (e.g., Nnwdaf_MLModelTraining), and an ML model training information request service (e.g., Nnwdaf_MLModelTrainingInfo).

The NWDAF 310 may subscribe to or unsubscribe from the ML model accuracy (e.g., the analytics accuracy of the ML model) information monitored through an Nnwdaf_MLModelMonitor service. The Nnwdaf_MLModelMonitor service may additionally provide analytics feedback information and/or analytics accuracy information on analytics generated by the NWDAF 310. The NWDAF 310 may register the use and monitoring capabilities of the ML model to the NWDAF 330 that is a model provider. The Nnwdaf_MLModelMonitor service may include an Nnwdaf_MLModelMonitor_Subscribe service operation, an Nnwdaf_MLModelMonitor_Unsubscribe service operation, an Nnwdaf_MLModelMonitor_Notify service operation, an Nnwdaf_MLModelMonitor_Register service operation, and an Nnwdaf_MLModelMonitor_Deregister service operation.

(1) Nnwdaf_MLModelMonitor_Subscribe service operation

The Nnwdaf_MLModelMonitor_Subscribe service operation may subscribe to an NWDAF (e.g., the NWDAF 330), which provides an ML model, for ML model accuracy (e.g., the analytics accuracy of a model) information and analytics feedback information (e.g., analytics feedback information on analytics generated by an NWDAF (e.g., the NWDAF 310) including an AnLF) using a predetermined parameter.

i) Inputs, Required:

Unique ML model identifier (or a set of unique ML model identifiers), notification target address (+notification correlation ID).

ii) Inputs, Optional:

Subscription correlation ID (e.g., in the case of modification of ML model monitoring subscription), accuracy metrics indicating metrics for accuracy information calculation, an ML model accuracy information period indicating a reporting periodicity for reporting information, and an accuracy reporting threshold indicating a reporting condition to report the accuracy information.

iii) Outputs, Required:

When the subscription is accepted: Subscription correlation ID (required to manage the subscription), an expiry time (required if the subscription is allowed to be expired based on a policy of an operator).

iv) Outputs, Optional: None.

(2) Nnwdaf_MLModelMonitor_Unsubscribe service operation

A consumer NF may unsubscribe from an NWDAF for ML model accuracy (e.g., analytics accuracy of an ML model) information and analytics feedback information on analytics generated by the NWDAF.

i) Inputs, Required: Subscription correlation ID.

ii) Outputs, Required: Operation execution result indication.

iii) Outputs, Optional: None.

(3) Nnwdaf_MLModelMonitor_Notify service operation

An NWDAF may notify a consumer instance subscribing to a specific NWDAF service of ML model accuracy (e.g., analytics accuracy of an ML model) information and analytics feedback information on analytics generated by the NWDAF (the same as the NWDAF mentioned above).

i) Inputs, Required: Notification correlation information, at least one of the following:
Tuple (e.g., a unique ML model identifier, ML model accuracy information): The ML model accuracy information may include a deviation value indicating a deviation of prediction generated by using an ML model from ground truth data, network data shown as an ADRF ID and/or DataSetTag when the deviation occurs (e.g., an NWDAF including an MTLF may be used for available ML model retraining), and an accuracy metric requested by the subscription service operation; and
Analytics feedback information: indicates that a consumer NF of analytics generated by a provisioned ML model takes an action affected by the analytics and includes the following parameter:
Analytics ID used to take an action;
Corresponding ML model identifier used for generating analytics;
Indication whether an action affects ground truth data (if available);
Timestamp when the action is performed.
(If available) Use case context (e.g., indicating an environment and a use case in which analytics (or analytics information) is used).

ii) Inputs, Optional: Validity period.

iii) Outputs, Required: Operation execution result indication.

iv) Outputs, Optional: None.

(4) Nnwdaf_MLModelMonitor_Register service operation

A consumer may register use and monitoring capabilities for an ML model to an NWDAF including an MTLF.

i) Inputs, Required: Consumer NF ID, unique ML model identifier.

ii) Inputs, Optional: Endpoint address of the Nnwdaf_MLModelMonitor_Subscribe service operation.

iii) Outputs, Required: ML model monitoring registration ID.

iv) Outputs, Optional: None.

(5) Nnwdaf_MLModelMonitor_Deregister service operation

When a consumer no longer uses or monitors the accuracy of analytics generated by using an ML model, the consumer may cancel previous ML Model Monitor registration from an NWDAF including an MTLF.

i) Inputs, Required: ML model monitoring registration ID.

ii) Inputs, Optional: None.

iii) Outputs, Required: None.

iv) Outputs, Optional: None.

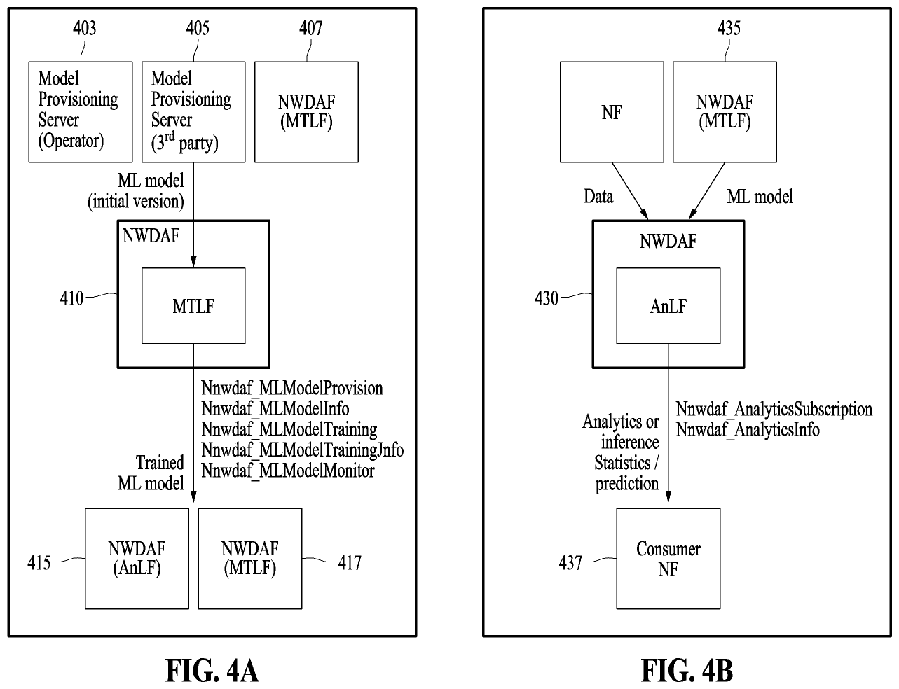

FIGS. 4A and 4B are diagrams illustrating a structure of an NWDAF according to one embodiment.

A description of an operation of an NWDAF 410 including an MTLF is provided with reference to FIG. 4A. The NWDAF 410 may receive an initial version of an ML model from a model provisioning server (operator) 403, a model provisioning server (third party) 405, or an NWDAF 407 including an MTLF. After the NWDAF 410 trains the initial version of ML model, the NWDAF 410 may provide a trained ML model to an NWDAF 415 including an AnLF or an NWDAF 417 including an MTLF through an ML model provisioning service (e.g., an Nnwdaf_MLModelProvision service) or an ML model information service (e.g., an Nnwdaf_MLModelInfo service). In addition, to update an ML model, the NWDAF 410 may use an Nnwdaf_MLModelTraining service or an Nnwdaf_MLModelTrainingInfo service.

A description of an operation of an NWDAF 430 including an AnLF is provided with reference to FIG. 4B. The NWDAF 430 may collect data from a DCCF apparatus and/or a data source (e.g., an NF or an ADRF). The NWDAF 430 may receive an ML model from an NWDAF 435 including an MTLF. The NWDAF 430 may analyze collected data using an ML model. The NWDAF 430 may provide an analytics result of the data in the form of statistics or prediction to a consumer NF apparatus 437.

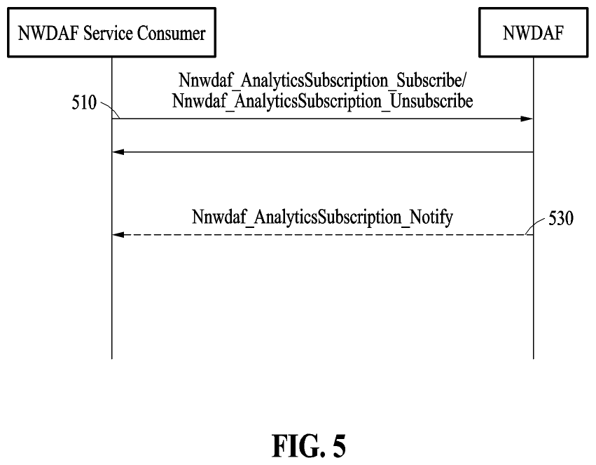

FIG. 5 is a diagram illustrating an example of a procedure for analytics subscription or unsubscription according to one embodiment.

FIG. 5 may be intended to describe a procedure to subscribe to or unsubscribe from (or cancel a subscription) analytics by an NWDAF service consumer (e.g., referred to as a consumer NF or a service consumer NF).

The NWDAF service consumer may be the AMF 120, the SMF 130, the UPF 140, the PCF 160, the NRF 170, the NEF 175, the MFAF 177, the NWDAF 180, the DCCF 185, the ADRF 187, the OAM 190, the UE 100, or the AF 150 of FIG. 1. The NWDAF may be substantially the same as the NWDAF (e.g., an NWDAF including at least one of an AnLF and an MTLF) described with reference to FIGS. 1 to 4.

The NWDAF service consumer may subscribe to and/or unsubscribe from the NWDAF for analytics information (e.g., a notification of analytics information). The NWDAF service consumer may use the Nnwdaf_AnalyticsSubscription service to subscribe to and/or unsubscribe from the NWDAF for the analytics information. In addition, the NWDAF service consumer may use the Nnwdaf_AnalyticsSubscription service to modify an existing analytics subscription.

In operation 510, an NWDAF service consumer may subscribe to or unsubscribe from analytics information by invoking an Nnwdaf_AnalyticsSubscribe_Subscribe or Nnwdaf_AnalyticsSubscribe_Unsubscribe service operation.

When a subscription to analytics information by the NWDAF service consumer is received, an NWDAF may determine whether it is required to trigger new data collection.

When the service invocation is for subscription modification in operation 510, the NWDAF service consumer may include an identifier to be modified (e.g., a subscription correlation ID) in invocation of Nnwdaf_AnalyticsSubscription_Subscribe. In addition, in operation 530, when the NWDAF service consumer takes an action (e.g., may affect or not affect ground truth data corresponding to an analytics ID requested at a time when prediction refers to) affected by previously received analytics information, the NWDAF service consumer may include analytics feedback information in invocation of Nnwdaf_AnalyticsSubscription_Subscribe.

When the subscription relates to an outbound roaming user, the NWDAF (e.g., an NWDAF in a home public land mobile network (HPLMN)) may determine whether to retrieve or subscribe to input data or analytics from a visited PLMN (VPLMN).

When the subscription relates to an inbound roaming user, the NWDAF (e.g., an NWDAF in a VPLMN) may determine whether to retrieve or subscribe to input data or analytics from an HPLMN.

In operation 530, when the NWDAF service consumer subscribes to analytics information, the NWDAF may notify the NWDAF service consumer of the analytics information by invoking the Nnwdaf_AnalyticsSubscription_Notify service operation based on a request (e.g., analytics reporting parameters) of the NWDAF service consumer. When the NWDAF provides a termination request, the NWDAF service consumer may unsubscribe from the analytics information by invoking the Nnwdaf_AnalyticsSubscription_Unsubscribe service operation.

When calculating analytics/ML model accuracy information using the retrieved analytics feedback information, other than comparing the prediction of an ML model with corresponding ground truth data, the NWDAF may additionally determine or consider whether an action taken by the NWDAF service consumer affects ground truth data corresponding to an analytics ID requested at a time when prediction refers to. This may affect ML model accuracy monitoring.

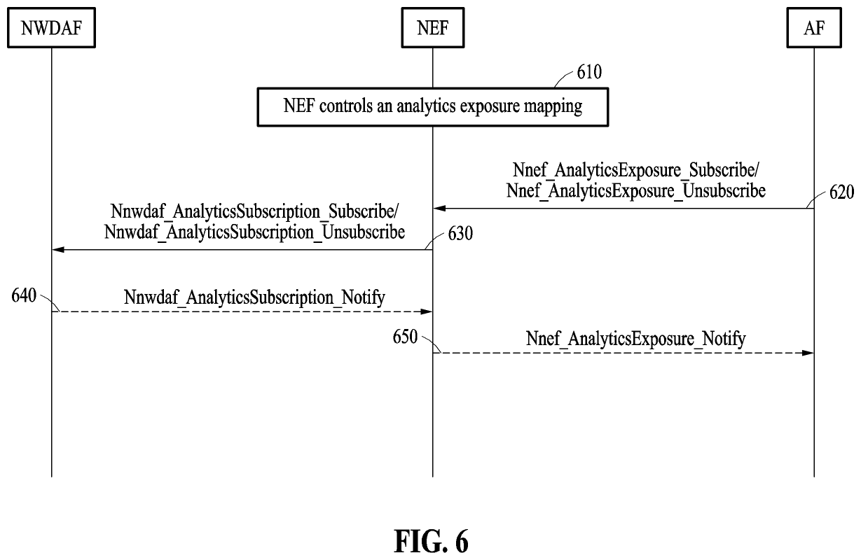

FIG. 6 is a diagram illustrating an example of a procedure for analytics subscription or unsubscription according to one embodiment.

FIG. 6 may be intended to describe a procedure of an AF to subscribe to or unsubscribe from analytics via an NEF, and may be intended to show an interaction between an NWDAF and an AF performed by an NEF. The NWDAF may be substantially the same as the NWDAF (e.g., an NWDAF including at least one of an AnLF and an MTLF) described with reference to FIGS. 1 to 5.

In operation 610, an NEF may control analytics exposure mapping between AF identifiers with an allowed analytics ID and/or associated inbound restrictions (e.g., applied to a subscription to an analytics ID for an AF) and/or outbound restrictions (e.g., applied to notification of an analytics ID for an AF).

The AF may be configured by an appropriate NEF to subscribe to analytics information, an allowed analytics ID, and allowed inbound restrictions (e.g., parameters and/or parameter values) for subscription to each analytics ID.

In operation 620, the AF may subscribe to or unsubscribe from the analytics information via the NEF by invoking an Nnef_AnalyticsExposure_Subscribe or Nnef_AnalyticsExposure_Unsubscribe service operation. When the AF desires to modify an existing analytics subscription in the NEF, the AF may cause an identifier to be modified (e.g., a subscription correlation ID) to be included in invocation of Nnef_AnalyticsExposure_Subscribe. In addition, in operation 650, when the AF takes an action (e.g., may affect or not affect ground truth data corresponding to an analytics ID requested at a time when prediction refers to) affected by previously received analytics information, the AF may include analytics feedback information in invocation of Nnef_AnalyticsExposure_Subscribe by re-triggering of operation 620. When the analytics information subscription is approved by the NEF, the NEF may proceed with the following operations.

In operation 630, based on a request by the AF, the NEF may subscribe to or may modify or cancel a subscription to the analytics information by invoking the Nnwdaf_AnalyticsSubscription_Subscribe or Nnwdaf_AnalyticsSubscription_Unsubscribe service operation. In operation 650, when the NEF receives the analytics feedback information, the NEF may include the analytics feedback information in invocation of Nnwdaf_AnalyticsSubscription_Subscribe by re-triggering of operation 630.

When parameters and/or parameter values of an AF request comply with inbound restrictions in analytics exposure mapping, the NEF may transmit the analytics ID, the parameters, and/or the parameter values from the AF request in the subscription to the NWDAF service.

When the request from the AF does not comply with restrictions in analytics exposure mapping, the NEF may apply a restriction (e.g., a restriction to parameters or parameter values of the Nnwdaf_AnalyticsSubscription_Subscribe service operation) to a subscription request to the NWDAF based on an operator configuration or may apply parameter mapping (e.g., geo coordinate mapping to a TA or cell-ID).

The NEF may record the association between the analytics request from the AF and the analytics request transmitted to the NWDAF.

The NEF may select an NWDAF supporting analytics information requested by the AF using an NWDAF discovery procedure.

When the subscription is associated with an outbound roaming user, the NWDAF in the HPLMN may determine to retrieve or subscribe to input data or analytics from the VPLMN.

When the AF request is a request to modify an existing analytics subscription, the NEF may modify the analytics subscription identified by an identifier (e.g., a subscription correlation ID) associated with the AF by invoking Nnwdaf_AnalyticsSubscription_Subscribe.

In operation 640, when the NEF subscribes to the analytics information, the NWDAF may notify the NEF of the analytics information or a termination request by invoking the Nnwdaf_AnalyticsSubscription_Notify service operation.

In operation 650, when the NEF receives a notification from the NWDAF, the NEF may send a notification to the AF with the analytics information or the termination request by invoking the Nnef_AnalyticsExposure_Notify service operation. The NEF may apply an outbound restriction (e.g., a restriction to parameters or parameter values of the Nnef_AnalyticsExposure_Notify service operation) to the notification to the AFs based on analytics exposure mapping and may apply parameter mapping (e.g., mapping a TA or a cell-ID to geo coordinates) for external usage. The AF may determine whether a termination request exists in the Nnef_AnalyticsExposure_Notify.

When calculating analytics/ML model accuracy information using the retrieved analytics feedback information, other than comparing the prediction of an ML model with corresponding ground truth data, the NWDAF may begin to evaluate an AF used as a data source or may additionally determine or consider whether an action taken by the AF affects ground truth data corresponding to an analytics ID requested at a time when prediction refers to. This may affect ML model accuracy monitoring.

An Nnef_AnlayticsExposure_service may include an Nnef_AnlayticsExposure_Subscribe service operation, an Nnef_AnalyticsExposure_Unsubscribe service operation, and an Nnef_AnalyticsExposure_Notify service operation.

(1) Nnef_AnlayticsExposure_Subscribe service operation

An NF consumer may subscribe to or modify an existing subscription to analytics information.

i) Inputs, Required:
Analytics ID (or a set of analytics IDs),
Analytics filter information
Target of analytics reporting (e.g., UE (e.g., a GPSI), an external group identifier, any UE),
Analytics reporting information
Notification target address (+notification correlation ID)

ii) Inputs, Optional:
Subscription correlation ID (e.g., when the analytics subscription is modified)
Expiry time
Slice specific information
Geographical area
Analytics feedback information:

The analytics feedback information indicates that an analytics consumer NF has taken an action affected by previously provided analytics (e.g., an analytics result), which may or may not affect ground truth data corresponding to an analytics ID requested at the time when prediction refers to, and may consequently affect ML model accuracy monitoring by subscription using the following parameter(s). The following parameter:
Analytics ID used to take an action;
(If available) Indication whether the action affects ground truth data;
Timestamp when an action is taken.
(Optional) Use case context (e.g., indicates a use case and an environment in which analytics (or analytics information) is used)

The analytics feedback information may be included only in a modification request for the existing analytics subscription.

iii) Outputs, Required:

When the subscription is accepted: Subscription correlation ID, expiry time (required if the subscription is allowed to be expired based on a policy of an operator)

iv) Outputs, Optional: A first corresponding analytics report is included if available.

(2) Nnef_AnalyticsExposure_Unsubscribe service operation

An NF consumer may cancel the existing subscription to the analytics information.

i) Inputs, Required: Subscription correlation ID

ii) Outputs, Required: Operation execution result indication

(3) Nnef_AnalyticsExposure_Notify service operation

An NEF may report analytics (e.g., an analytics result) to a previously subscribed NF consumer.

i) Inputs, Required: Analytics ID, notification correlation information, analytics information (e.g., defined by each ID).

ii) Inputs, Optional: Timestamp of analytics generation, probability assertion, and a termination request

iii) Outputs, Required: Operation execution result indication

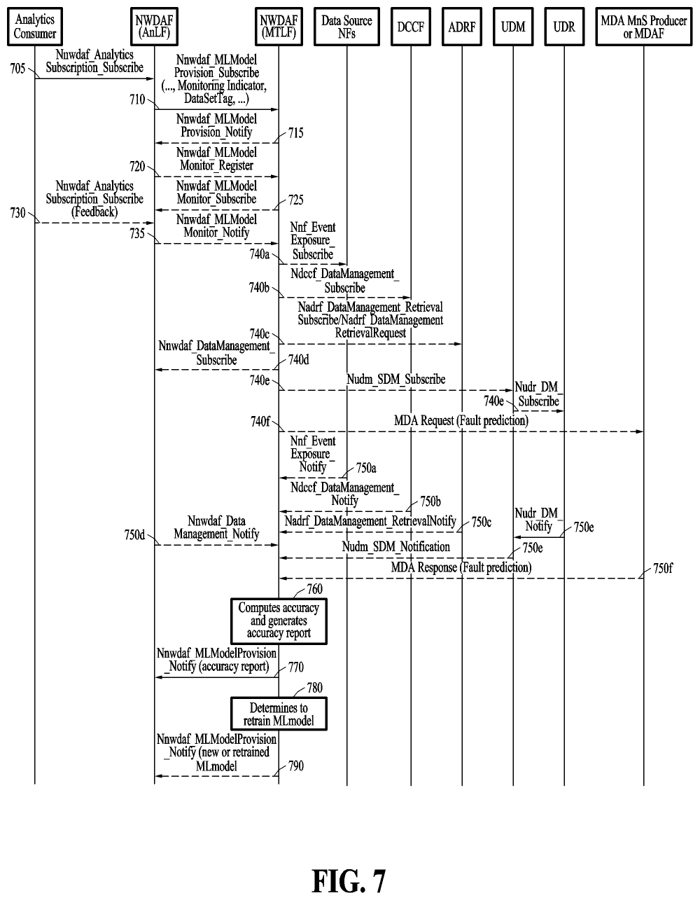

FIG. 7 illustrates an example of a procedure for machine learning (ML) model accuracy monitoring according to one embodiment.

An NWDAF including an MTLF may perform an MTLF-based ML model accuracy monitoring procedure. FIG. 7 may be intended to describe the MTLF-based ML model accuracy monitoring procedure. The MTLF-based ML model accuracy monitoring procedure may be a procedure for determining ML model degradation (e.g., ML model performance degradation) based on newly collected test data and retraining or reprovisioning an existing ML model.

FIG. 7 may show a procedure for monitoring the accuracy of an ML model provisioned using newly collected data. An NWDAF including an AnLF may provide inference data to the NWDAF including the MTLF for model accuracy monitoring and the NWDAF including the MTLF may determine retraining or reprovisioning of the ML model.

In operation 705, an analytics consumer (e.g., referred to as a consumer NF, a service consumer NF, or an NWDAF service consumer) may initiate a subscription to an analytics exposure service for an NWDAF including an AnLF.

In operation 710, the NWDAF including the AnLF may send a request to an NWDAF including an MTLF (e.g., an appropriate NWDAF) for an ML model using an Nnwdaf_MLModelProvision_Subscribe service operation. The NWDAF including the AnLF may include an analytics accuracy threshold used as an indicator (e.g., a monitoring indicator) to execute an accuracy monitoring operation. The NWDAF including the AnLF may include DataSetTag and/or an ADRF ID. These (e.g., DataSetTag and/or the ADRF ID) may be used to load, from the ADRF, and store inference data (e.g., including input data, prediction, and ground truth data at a time when prediction refers to) relevant to ML model accuracy monitoring and retraining or reprovisioning. Nnwdaf_MLModelProvision_Subscribe may include a monitoring indicator, DataSetTag and/or the ADRF ID.

In operation 715, the NWDAF including the MTLF may provide a trained ML model to the NWDAF including the AnLF. The NWDAF including the MTLF may include accuracy information used to indicate the accuracy of the ML model during training. Nnwdaf_MLModelProvision_Notify may include the accuracy information.

In operation 720, the NWDAF including the AnLF may register the use of the ML model to the NWDAF including the MTLF. The NWDAF including the AnLF may show a capability of transmitting analytics feedback information of the analytics consumer and/or the ML model accuracy information on the ML model by registering the use of the ML model to the NWDAF including the MTLF.

In operation 725, due to the registration in operation 720, the NWDAF including the MTLF may subscribe to the NWDAF including the AnLF to obtain the analytics feedback information from the analytics consumer and/or the ML model accuracy information on the provisioned ML model by invoking the Nnwdaf_MLModelMonitor_Subscribe service operation. This may be a case in which a corresponding service operation (e.g., the Nnwdaf_MLModelMonitor_Subscribe service operation) is supported by the NWDAF including the AnLF.

In operation 730, the analytics consumer may transmit the analytics feedback information as an Nnwdaf_AnalyticsSubscription_Subscribe message.

In operation 735, as requested in operation 725, the NWDAF including the AnLF may transmit the ML model accuracy information on the provisioned ML model and/or the analytics feedback information received from the analytics consumer by invoking the Nnwdaf_MLModelMonitor_Notify service operation. When the NWDAF including the MTLF receives the analysis feedback information or the ML model accuracy, the NWDAF including the MTLF may improve the ML model accuracy by triggering operations 740a to 790.

In operations 740a to 740f, the NWDAF including the MTLF may determine whether to perform ML model accuracy monitoring and retraining or reprovisioning of the ML model by collecting new data from various data sources based on the NWDAF (e.g., at least one) including the AnLF or a request of a corresponding local policy.

In operations 740a and 740b, the NWDAF including the MTLF may collect new data for ML model accuracy monitoring, retraining, and reprovisioning from data source NFs and a DCCF by respectively invoking Nnf_EventExposure_Subscribe and Ndccf_DataManagement_Susbscribe service operations.

In operations 740c and 740d, when the ADRF ID and/or DataSetTag is provided in operation 710, the NWDAF including the MTLF may retrieve historical data (e.g., historical analytics) from an ADRF designated by the NWDAF including the AnLF in operation 710 by invoking an Nadrf_DataManagementRetrievalRequest or Nadrf_DataManagementRetrieval_Subscribe service operation. Otherwise, the NWDAF including the MTLF may retrieve historical data (e.g., historical analytics) from the NWDAF including the AnLF or the DCCF by respectively invoking Ndccf_DataManagement_Subscribe and Nnwdaf_DataManagement_Subscribe service operations.

When the NWDAF including the AnLF does not include DataSetTag having the ADRF ID in operation 710, the NWDAF including the MTLF may send a request to the ADRF for data collection and analytics corresponding to the analytics generated by the ML model provided in operation 715.

In operation 740e, the NWDAF including the MTLF may subscribe the UDM to receive a notification of modification within subscription data for a target of ML model reporting (e.g., (list of) UE) by invoking an Nudm_SDM_Subscribe service operation and the UDM may subscribe to a notification of modification of UE subscription data by invoking an Nudr_DM_Subscribe service operation of a UDR.

In operation 740f, the NWDAF including the MTLF may consider data quality for accuracy monitoring by collecting fault prediction analytics data from an MDAS (Management Data Analytics Service) to determine states of data source NFs using an MDA (Management Data Analytics) request.

When the NWDAF including the MTLF already collected new test data and performed ML model accuracy monitoring and retraining (e.g., triggered by another NWDAF including an AnLF for ML model accuracy monitoring and retraining), the NWDAF including the MTLF may determine whether to use data to subscription based on its internal logic.

In operations 750a to 750f, the NWDAF including the MTLF may receive data requested by various sources as requested in operations 740a to 740f.

In operation 760, based on the data and analytics collected in operations 750a to 750f, the NWDAF including the MTLF may compute accuracy using prediction and actual measured data observed at a time when the prediction refers to. The NWDAF including the MTLF may discard data of a corresponding data source when NWDAF including the MTLF detects that the data quality of the data source is poor. When only the input data and ground truth data are allowed to be used, the NWDAF including the MTLF may generate prediction with the input data collected to compute the accuracy.

A method in which the NWDAF including the MTLF determines whether data from a data source is good quality or needs to be discarded may depend on NWDAF implementation and configuration.

In operation 770, the NWDAF including the MTLF may transmit an accuracy report (e.g., including the accuracy computed in operation 760) to the NWDAF including the AnLF. For example, when a reporting threshold is satisfied, the NWDAF including the MTLF may transmit the accuracy report to the NWDAF including the AnLF by invoking an Nnwdaf_MLModelProvision_Notify service operation.

In operation 780, based on the computed accuracy, the NWDAF including the MTLF may retrain or reprovision an ML model.

In operation 790, when a newly generated ML model or a retrained ML model is prepared, the NWDAF including the MTLF may transmit the newly generated ML model or the retrained ML model to the NWDAF including the AnLF by invoking the Nnwdaf_MLModelProvision_Notify service operation. The NWDAF including the MTLF may transmit the accuracy report of the newly generated ML model or the retrained ML model to the NWDAF including the AnLF.

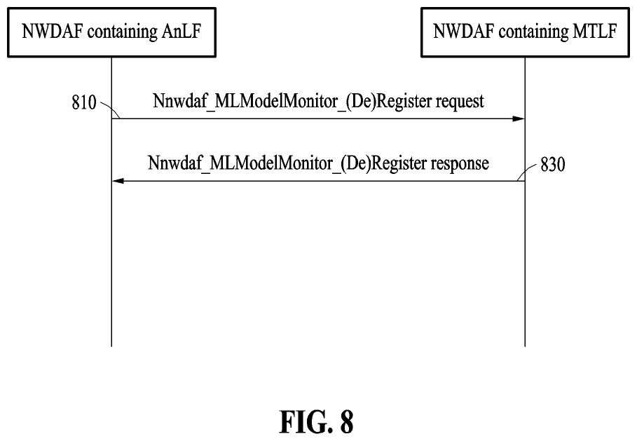

FIG. 8 is a diagram illustrating a registration procedure for ML model accuracy monitoring according to one embodiment.

An NWDAF including an AnLF may perform a procedure for AnLF-assisted ML model accuracy monitoring.

When the NWDAF including the AnLF initiates the use of an ML model and monitors the accuracy of analytics generated by the ML model for a given analytics ID, the NWDAF including the AnLF may register with an NWDAF including an MTLF. The NWDAF including the AnLF may assume that the ML model is obtained through a previous interaction (e.g., the use of an Nnwdaf_MLModelInfo or Nnwdaf_MLModelProvision service) with the NWDAF including the MTLF. Through this registration, the NWDAF including the MTLF may recognize the NWDAF including the AnLF using the given ML model for a specific analytics ID and the NWDAF including the AnLF may support a capability of monitoring the accuracy of the analytics.

The NWDAF including the MTLF may subscribe to the NWDAF including the AnLF to which an existing Nnwdaf_MLModelProvision service is set to receive a notification of the accuracy of the analytics generated by the given ML model for a specific analytics ID. The NWDAF including the AnLF may generate accuracy information in various methods (e.g., comparing prediction of an ML model with corresponding ground truth data, comparing changes in an internal configuration to generate an analytics ID, an existing record on analytics accuracy information, and the like).

FIG. 8 may be intended to describe a procedure to register monitoring of analytics accuracy of an ML model. When an NWDAF including an AnLF starts using an ML model, monitors the analytics accuracy of the ML model, and has a capability of transmitting analytics feedback information on analytics generated by the ML model, the NWDAF including the AnLF may register the NWDAF including the AnLF to an NWDAF including an MTLF that is responsible for training or updating the ML model. When the NWDAF including the AnLF no longer uses the ML model or no longer monitors the accuracy of analytics generated by the ML model for an analytics ID, the NWDAF including the AnLF may cancel registration (de-register) to the NWDAF including the MTLF.

FIG. 8 may be intended to describe a procedure to register to an NWDAF including an MTLF such that an NWDAF including an AnLF starts using and monitoring the analytics accuracy of an ML model.

The NWDAF including the AnLF may start monitoring the accuracy of the ML model based on a local policy or a request of a service consumer (e.g., an NWDAF including an MTLF).

In operations 810 to 830, the NWDAF including the AnLF may transmit an Nnwdaf_MLModelMonitor_Register request (e.g., including an NF ID of the NWDAF including the AnLF and/or a unique identifier of the ML model, and selectively including a subscription endpoint of an Nnwdaf_MLModelMonitor_Subscribe service operation in the NWDAF including the AnLF) to the NWDAF including the MTLF. The NWDAF including the MTLF may recognize an NF ID of the NWDAF including the AnLF that monitors the accuracy of the ML model.

When the NWDAF including the AnLF no longer uses the ML model, the NWDAF including the AnLF may transmit an Nnwdaf_MLModelMontior_Deregister service operation. The NWDAF including the MTLF may delete associated data.

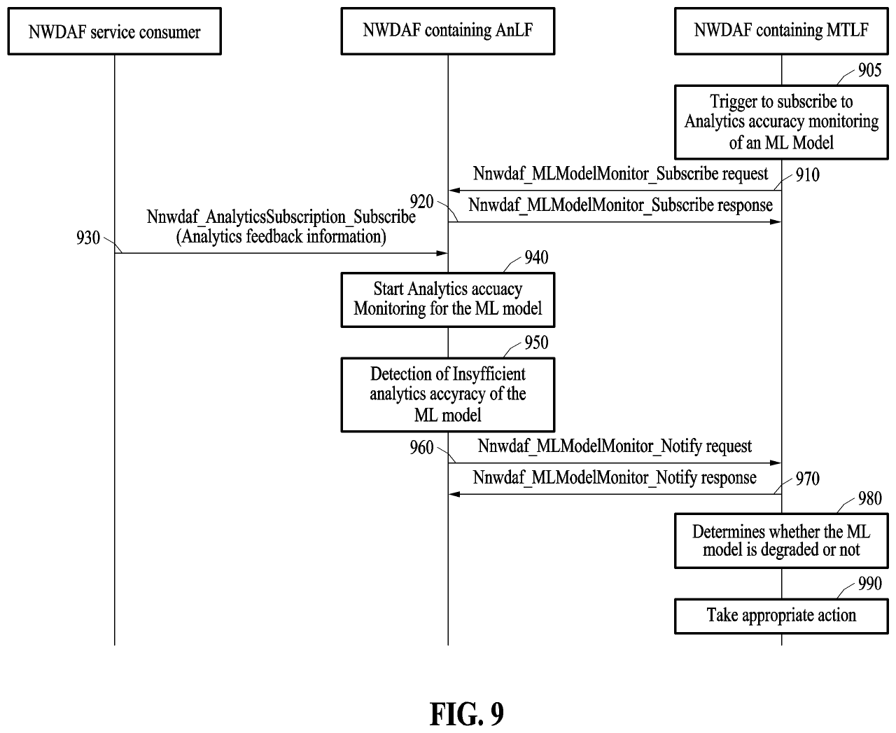

FIG. 9 illustrates another example of a procedure for ML model accuracy monitoring according to one embodiment.

Due to a local policy and analytics accuracy monitoring the registration of an ML model received from an NWDAF including an AnLF, the NWDAF including an MTLF may subscribe to the NWDAF including the AnLF to receive a notification of analytics feedback information of the ML model or the accuracy of the ML model. The NWDAF including the MTLF may obtain a subscription endpoint address of the NWDAF including the AnLF from information received from a previous registration or a service discovery procedure in an NRF.

FIG. 9 shows a procedure for monitoring analytics accuracy of the ML model or transmitting analytics feedback information of the ML model. For this, Nnwdaf_MLModelMonitor_Subscribe and Nnwdaf_MLModelMonitor_Notify service operations may be used. A service consumer (e.g., the NWDAF including the MTLF) may subscribe to a service producer (e.g., the NWDAF including the AnLF) in order to receive a notification when the analytics accuracy of a previously provisioned ML model is not sufficient or analytics feedback information is retrieved from an analytics consumer NF.

In operation 905, the NWDAF including the MTLF may trigger subscription to monitor the analytics accuracy of an ML model. In response to the reception of a request and a local policy, the NWDAF including the MTLF may determine to subscribe to the analytics accuracy monitoring for the ML model.

In operation 910, the NWDAF including the MTLF may transmit an Nnwdaf_MLModelMonitor_Subscribe request (e.g., including an analytics ID, a unique identifier of an ML model to be monitored, accuracy metrics to monitor, and optionally including a reporting threshold and/or a reporting period) to an NWDAF including an AnLF subscription endpoint.

In operation 920, the NWDAF including the AnLF may transmit a response (e.g., an Nnwdaf_MLModelMonitor_Subscribe response) to the NWDAF including the MTLF.

In operation 930, the analytics consumer NF may transmit the analytics feedback information to the NWDAF including the AnLF.

In operation 940, when the operation 905 is triggered (e.g., in the case in which the NWDAF including the MTLF triggers subscription for analytics accuracy monitoring for the ML model), the NWDAF including the AnLF may start analytics accuracy monitoring of the ML model (e.g., when analytics accuracy monitoring of the ML model has not started).

The NWDAF including the AnLF may monitor analytics accuracy in various methods: for example, the various methods may include comparing the prediction of the ML model and corresponding actual measured data, comparing a change in an internal configuration for generating an analytics ID, and comparing previous records on the analytics accuracy information.

In operation 950, the NWDAF including the AnLF may determine whether the analytics accuracy of the ML model is insufficient. For example, the NWDAF including the AnLF may determine whether a deviation of output analytics using an ML model trained with ground truth data (e.g., collected from a data producer NF corresponding to an analytics ID requested at a time when prediction refers to) is greater than a reporting threshold (e.g., locally configured or received from a subscription request) or whether a reporting period shown in the subscription request has reached.

In operation 960, when the analytics feedback information is retrieved in operation 930 or it is determined that the analytics accuracy of the ML model is insufficient in operation 950, the NWDAF including the AnLF may transmit an Nnwdaf_MLModelMonitor_Notify request to a notification endpoint (e.g., the NWDAF including the MTLF). The notification request may include the analytics feedback information or the analytics accuracy information of the ML model (e.g., a deviation value indicating a deviation between ground truth data and prediction generated by using the ML model), network data when a deviation occurs (e.g., the NWDAF including the MTLF may use this for retraining the ML model), the number of inferences performed during a time interval between an Nnwdaf_MLModelMonitor_Register request and a notification request or between the time of a last notification message and the time of a current notification message, and optionally, an indication that the analytics accuracy of the ML model does not satisfy a requirement of the accuracy of the ML model.

In operation 970, the NWDAF including the MTLF may transmit a response (e.g., an Nnwdaf_MLModelMonitor_Notify response).

In operation 980, the NWDAF including the MTLF may determine whether the ML model is degraded (e.g., whether the performance of the ML model is degraded) based on the notification (e.g., the Nnwdaf_MLModelMonitor_Notify request) of operation 960. When the notification includes the analytics feedback information, the NWDAF including the MTLF may determine ML model degradation based on the procedure described with reference to FIG. 7. Otherwise, when the NWDAF including the MTLF receives multiple analytics accuracy information from one or more NWDAFs including the AnLF, the ML model may be considered to be degraded or updated (e.g., indicating that the analytics accuracy is insufficient by receiving a sufficient number of pieces of analytics accuracy information from one or more NWDAFs including the AnLF).

An actual mechanism of the NWDAF including the MTLF to determine ML model degradation may be an internal procedure of the NWDAF including the MTLF, for example, the NWDAF including the MTLF may compute global accuracy based on the analytics accuracy information and the number of inferences received from multiple NWDAFs including the AnLF.

In operation 990, when it is determined that the ML model is degraded or updated in operation 980, the NWDAF including the MTLF may retrain an existing ML model or may select a new ML model. When network data is not included in the Nnwdaf_MLModelMonitor_Notify request in operation 950, the NWDAF including the MTLF may send a request to the NWDAF including the AnLF, the ADRF, and/or other 5GS entities for data and may use the collected data for retraining the ML model. The NWDAF including the MTLF may notify the NWDAF including the AnLF of information on the updated and trained ML model by invoking the Nnwdaf_MLModelProvision_Notify service operation.

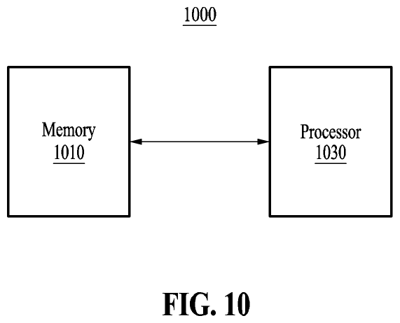

FIG. 10 is a schematic block diagram of an apparatus for performing an NWDAF according to one embodiment.

Referring to FIG. 10, according to one embodiment, an apparatus 1000 for performing an NWDAF (e.g., a server apparatus) may be substantially the same as the NWDAF (e.g., an NWDAF including an AnLF or an NWDAF including an MTLF) described with reference to FIGS. 1 to 9. The apparatus 1000 may include a memory 1010 and a processor 1030. The apparatus 1000 may function as an NWDAF including an AnLF or an NWDAF including an MTLF.

The memory 1010 may store instructions (or programs) executable by the processor 1030. For example, the instructions include instructions for performing an operation of the processor 1030 and/or an operation of each component of the processor 1030.

The memory 1010 may be implemented as a volatile or non-volatile memory device. The volatile memory device may be implemented as dynamic random-access memory (DRAM), static random-access memory (SRAM), thyristor RAM (T-RAM), zero capacitor RAM (Z-RAM), or twin transistor RAM (TTRAM). The non-volatile memory device may be implemented as electrically erasable programmable read-only memory (EEPROM), flash memory, magnetic RAM (MRAM), spin-transfer torque (STT)-MRAM, conductive bridging RAM (CBRAM), ferroelectric RAM (FeRAM), phase change RAM (PRAM), resistive RAM (RRAM), nanotube RRAM, polymer RAM (PoRAM), nano floating gate Memory (NFGM), holographic memory, a molecular electronic memory device, and/or insulator resistance change memory.

The processor 1030 may execute computer-readable code (e.g., software) stored in the memory 1010 and instructions triggered by the processor 1030. The processor 1030 may be a data processing device implemented by hardware including a circuit having a physical structure to perform desired operations. The desired operations may include code or instructions included in a program. For example, the hardware-implemented data processing device may include a microprocessor, a CPU, a processor core, a multi-core processor, a multiprocessor, an application-specific integrated circuit (ASIC), and a field-programmable gate array (FPGA).

An operation performed by the processor 1030 may be substantially the same as the operation of the NWDAF (e.g., the NWDAF including the AnLF or the NWDAF including the MTLF) described with reference to FIGS. 1 to 9. Accordingly, a detailed description thereof is omitted.

The components described in the example embodiments may be implemented by hardware components including, for example, at least one digital signal processor (DSP), a processor, a controller, an application-specific integrated circuit (ASIC), a programmable logic element, such as a field programmable gate array (FPGA), other electronic devices, or combinations thereof. At least some of the functions, or the processes described in the example embodiments, may be implemented by software, and the software may be recorded on a recording medium. The components, the functions, and the processes described in the example embodiments may be implemented by a combination of hardware and software.

The units described herein may be implemented using a hardware component, a software component and/or a combination thereof. A processing device may be implemented using one or more general-purpose or special-purpose computers, such as, for example, a processor, a controller and an arithmetic logic unit (ALU), a DSP, a microcomputer, an FPGA, a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to the execution of the software. For the purpose of simplicity, the description of a processing device is used as singular; however, one skilled in the art will appreciate that a processing device may include multiple processing elements and multiple types of processing elements. For example, the processing device may include a plurality of processors, or a single processor and a single controller. In addition, different processing configurations are possible, such as parallel processors.

The software may include a computer program, a piece of code, an instruction, or some combination thereof, to independently or collectively instruct or configure the processing device to operate as desired. Software and data may be stored in any type of machine, component, physical or virtual equipment, or computer storage medium or device capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described examples may be recorded in non-transitory computer-readable media including program instructions to implement various operations of the above-described examples. The media may also include, alone or in combination with the program instructions, data files, data structures, and the like. The program instructions recorded on the media may be those specially designed and constructed for the purposes of examples, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher-level code that may be executed by the computer using an interpreter.

The above-described devices may be configured to act as one or more software modules in order to perform the operations of the above-described examples, or vice versa.

As described above, although the examples have been described with reference to the limited drawings, a person skilled in the art may apply various technical modifications and variations based thereon. For example, suitable results may be achieved if the described techniques are performed in a different order and/or if components in a described system, architecture, device, or circuit are combined in a different manner and/or replaced or supplemented by other components or their equivalents.

Accordingly, other implementations are within the scope of the following claims.

What is claimed is:

1. A method of using feedback information, the method comprising:
requesting a machine learning (ML) model;
receiving feedback information of an information consumer provided with information generated through the ML model;
monitoring accuracy of the ML model; and
providing at least one of the feedback information and information on the accuracy.

2. The method of claim 1, further comprising:
when a consumer uses the ML model and has a capability of transmitting feedback information on analytics generated by the ML model, registering the consumer to a provider providing the ML model.

3. The method of claim 2, wherein a request for the registering comprises at least one of an identifier of a consumer provided with the ML model and an identifier of the ML model.

4. The method of claim 1, wherein the providing comprises transmitting the at least one in response to a request for subscription to accuracy monitoring of the ML model.

5. The method of claim 1, further comprising:
computing the accuracy based on the feedback information.

6. The method of claim 1, wherein the at least one is used for evaluation of the ML model.

7. The method of claim 1, further comprising:
receiving the ML model that is retrained or a newly selected ML model based on the at least one.

8. The method of claim 1, wherein the feedback information is received via a network exposure function (NEF).

9. The method of claim 1, wherein the feedback information comprises use case context.

10. A server apparatus for using feedback information, the server apparatus comprising:
a processor; and
a memory electrically connected to the processor and configured to store instructions executable by the processor,
wherein the processor performs a plurality of operations when the instructions are executed by the processor, and
wherein the plurality of operations comprises:
requesting a machine learning (ML) model;
receiving feedback information of a consumer provided with information generated through the ML model;
monitoring accuracy of the ML model; and
providing at least one of the feedback information and information on the accuracy.

11. The server apparatus of claim 10, wherein the plurality of operations further comprises:
when a consumer uses the ML model and has a capability of transmitting feedback information on analytics generated by the ML model, registering the consumer to a provider providing the ML model.

12. The server apparatus of claim 11, wherein a request for registration comprises at least one of an identifier of a consumer provided with the ML model and an identifier of the ML model.

13. The server apparatus of claim 10, wherein the providing comprises transmitting the at least one in response to a request for subscription to accuracy monitoring of the ML model.

14. The server apparatus of claim 10, wherein the plurality of operations further comprises:
computing the accuracy based on the feedback information.

15. The server apparatus of claim 10, wherein the at least one is used for evaluation of the ML model.

16. The server apparatus of claim 10, wherein the plurality of operations further comprises:
receiving the ML model that is retrained or a newly selected ML model based on the at least one.

17. The server apparatus of claim 10, wherein the feedback information is received via a network exposure function (NEF).

18. The server apparatus of claim 10, wherein the feedback information comprises use case context.
